(19) United States
(12) Patent Application Publication
(10) Pub. No.: US 2015/0124561 A1
(43) Pub. Date: May 7, 2015

(54) Sound Velocity Profile Streamlining and Optimization Method Based on Maximum Offset of Velocity

(71) Applicant: The Second Institute of Oceanography, State Oceanic Administration, Hangzhou City (CN)

(72) Inventors: Ziyin Wu, Hangzhou City (CN); Dineng Zhao, Hangzhou City (CN); Jieqiong Zhou, Hangzhou City (CN); Shoujun Li, Hangzhou City (CN); Jihong Shang, Hangzhou City (CN)

(73) Assignee: The Second Institute of Oceanography, State Oceanic Administration, Hangzhou City (CN)

(21) Appl. No.: 14/535,783

(22) Filed: Nov. 7, 2014

(30) Foreign Application Priority Data
Nov. 7, 2013 (CN) 2013105497800

(51) Int. Cl. G01V 1/30

(52) U.S. Cl. CPC G01V 1/303; G01V 2210/6222
USPC 367/14

(57) ABSTRACT

The invention discloses a sound velocity profile (SVP) streamlining and optimization method based on maximum offset of velocity, and provides detailed comprehensive technical process so as to solve the problem that the work efficiency of multi-beam detection and data processing are seriously influenced because the original sound velocity profile has a large data quantity. An MOV method is provided and is used for deleting the redundant points automatically and quickly, and for evaluating the influence of the streamlined sound velocity profile on precision of multi-beam sounding through ray tracing and error analysis. The method has an important actual application value in the aspects of marine surveying and charting, multi-beam surveying, a marine geographic information system, computer graphics, submarine science research and the like, and can be popularized.

### FIELD OF THE INVENTION

The present invention relates to the field of submarine topography mapping, marine surveying, marine geographic information system, computer graphics and underwater science.

### BACKGROUND OF THE INVENTION

Sound Velocity Profile (SVP) is a basic parameter for multi-beam echo sounding survey. Generally, the SVP is determined directly by a device or indirectly by using a sound velocity empirical model. At present, the sampling frequency of a device for measuring the SVP can be up to 20 Hz. Therefore, for a sink rate of 1 m/s, the number of SVP points will reach 2000 for a water depth of 100 m, and the quantity of data will be enormous for a survey over a depth of 1000 m or more. Because of the high sampling rate, the operating time of ray tracing and beam footprint reduction will increase in large scale, thus reducing the overall efficiency, and preventing the multi-beam system from working properly. Consequently, many multi-beam echo sounding systems have to limit the number of SVP data points; for example, the deep multi-beam system SeaBeam 2112 limits an SVP data file up to 30 lines. Another example is the Konnsberg EM series multi-beam system, the file used by the PU processing unit should be smaller than 30 kB and it is limited to a maximum number of depth points: 1000 for the EM 2040, EM 710, EM 302 and EM 122 sensors and a maximum of 570 points for the older sounders. To promote the productivity of multi-beam surveys and data processing, redundant points in the original SVP must be screened out and at the same time, errors following the streamlining of the SVP must be evaluated and controlled.

In the art, the SVP feature points are selected manually. However, it is inefficient and difficult to evaluate the SVP accuracy. In addition, it tends to miss the SVP feature points. Typical existing procedures employ sub-sampling the profile by calculating the mean value in vertical bins of fixed size, which could miss the feature points of the original SVP.

CN 20130152512 “A Measured Sound Velocity Profile Reconstruction Method Applicable for Submarine Detection and False Terrain Processing” mentioned that “applying D-P algorithm, feature extraction and fitting are introduced to original sound velocity profile, adjusting deviation factor D of curve to fit and streamline the original sound velocity profile, retaining inflection point of the original sound velocity profile”. The patent aimed at extracting features of sound velocity profile rather than deleting redundant point, meanwhile the patent didn't provide much technical details of streamlining sound velocity profile. The most important point is that distance judgment method based on D-P algorithm can't be adopted directly to streamline sound velocity profile on account of different coordinate dimensions of sound velocity profile. Since the underlying physical and mathematical models of this algorithm have been changed, the patent didn't provide any concrete plans to solve the problem of different coordinate dimensions.

### SUMMARY OF THE INVENTION

This invention aims to provide a solution to the existing problem that large amount of original sound velocity profile data seriously affect work efficiency of multi-beam echo sounding survey. In addition, the invention provides a sound velocity profile streamlining and optimization method based on maximum offset of velocity.

According to one embodiment of present disclosure, a sound velocity profile streamlining and optimization method based on maximum offset of velocity, comprising the steps of:

1) forming original sound velocity profile dataset,

1.1) if there are sound velocity profiles, forming the original sound velocity profile dataset SVPᵢₙ={in_svpₜ}_{t=1,n} directly, wherein i is numerical order of the sound velocity profile, n is the number of the collected sound velocity profiles, i and n are both natural numbers;

1.2) if there are no sound velocity profiles, using sound velocity profile acquisition apparatus, obtaining the original sound velocity profiles, forming the original sound velocity profile dataset SVPᵢₙ={in_svpₜ}_{t=1,n};

1.3) for each said sound velocity profile

$$\text{?} = \{ {p}_{j} = ( \text{?} , {v}_{j} ) \} \text{?} , \\ \text{?} \text{indicates text missing or illegible when filed}$$

wherein Pⱼ is a sound velocity profile point, dⱼ and vⱼ are corresponding depth value and sound velocity value of each said sound velocity profile point Pⱼ respectively, m is the number of the valid sound velocity profile points, j and m are both natural numbers;

1.4) outputting a sound velocity profile in_svpₜ;

2) determining optimized threshold interval,

2.1) inputting the sound velocity profile in_svpₜ;

2.2) traversing the sound velocity profile in_svpₜ, obtaining minimum vₛ and maximum vₛ of the sound velocity profile;

$$\text{?} = 0.001 \times ( \text{?} - {v}_{s} ) , \\ \text{?} \text{indicates text missing or illegible when filed}$$

wherein Tₛₜₑₚ is an automatically calculating step of threshold;

initializing

$$\text{?} = \text{?} , \\ \text{?} \text{indicates text missing or illegible when filed}$$

wherein Tₖ is the present sound velocity streamlining threshold;

2.3) setting the threshold automatically:

$${T}_{k} = {T}_{k} + \text{?} ;$$

$$\text{?} \text{indicates text missing or illegible when filed}$$

2.4) initializing current threshold

$$\text{?} = {T}_{k} , \\ \text{?} ∈ \text{?} , \\ \text{?} \text{indicates text missing or illegible when filed}$$

wherein V_{cur} is current processing sound velocity profile segment,

$$\text{?} = \{ {p}_{j} = ( \text{?} , {v}_{j} ) \} \text{?} , \\ \text{?} \text{indicates text missing or illegible when filed}$$

wherein a is first point and b is last point of the current processing sound velocity profile segment, and both a and b are natural numbers; initializing

$$\text{?} = \text{?} = \{ {p}_{j} = ( \text{?} , {v}_{j} ) \} \text{?} ;$$

$$\text{?} \text{indicates text missing or illegible when filed}$$

2.5) deleting redundant point of the sound velocity profile:

2.5.1) extracting the first point

$${P}_{a} = ( {d}_{a} , {v}_{a} )$$

$$and the last point$$

$${P}_{b} = ( {d}_{b} , {v}_{b} )$$

of the current sound velocity profile dataset V_{cur};

2.5.2) traversing the current sound velocity dataset V_{cur}, extracting each said sound velocity profile point Pⱼ in order, applying equation (1) to calculate offset value Dᵢ in sound velocity dimension of Pⱼ:

$$\text{?} = abs [ \frac{( {v}_{j} - \text{?} ) \text{?} ( {d}_{j} - \text{?} )}{{v}_{b} - {v}_{a}} + \text{?} - {v}_{j} ] \\ \text{?} \text{indicates text missing or illegible when filed} \qquad ( 1 )$$

storing maximum offset value Dⱼ into Dₘₐₓ, and storing the corresponding sound velocity profile point Pⱼ into Pₖ, wherein Pₖ is a temporary sound velocity profile;

One feature of the invention is that retaining feature points of sound velocity profile is based on calculating maximum offset value of sound velocity dimension, in order to solve the problem that horizontal and vertical dimensions of two-dimensional sound velocity profile are different. Therefore the invention is also called MOV method (Maximum Offset of sound Velocity).

2.5.3) if Dₘₐₓ>T_{cur}, adding Pₖ to Vₜₘₚ, wherein Vₜₘₚ is a temporary sound velocity profile dataset, partitioning the current sound velocity profile dataset V_{cur} from Pₖ into two segments, which are V_{cur1}={Pⱼ}_{j=a,k} and V_{cur2}={Pⱼ}_{j=k,b};

2.5.4) if Dₘₐₓ≦T_{cur}, adding P₁ and Pₘ to Vₜₘₚ;

2.6) outputting streamlined sound velocity profile: out_svpₜ=Vₜₘₚ−{Pⱼ=(dⱼ,vⱼ)}_{j=1,mo}, wherein mo is the number of streamlined sound velocity profile points, and mo is a natural number; wherein out_svgₜ is corresponding to in_svpₜ, and out_svpₜ is a new sound velocity profile formed by reducing redundancy under the threshold T_{cur};

2.7) outputting reduction rate:

$$\text{?} = ( 1 - \frac{\text{?}}{m} ) \times 100 \% ;$$

$$\text{?} \text{indicates text missing or illegible when filed}$$

2.8) obtaining reduction rate parameter Parₖ, adding Parₖ to dataset

$$\{ ( {T}_{k} , \text{?} ) \} \text{?} ;$$

$$\text{?} \text{indicates text missing or illegible when filed}$$

2.9)

$$if \text{?} < \text{?} - {v}_{s} , \\ \text{?} \text{indicates text missing or illegible when filed}$$

returning to the step 2.3);

2.10) using Tₖ as horizontal axis, Parₖ as vertical axis, obtaining reduction rate curve, and calculating second derivative of the reduction rate, obtaining second derivative curve f_{(T}_{ₖ}_{Par}_{ₖ}₎;

2.11) traversing the second derivative curve f_{(T}_{ₖ}_{Par}_{ₖ}₎, obtaining absolute value interval [fₘᵢₙ,fₘₐₓ], setting curve blocking value

$$\text{?} = 0.1 \times \vert {f}_{max} - {f}_{min} \vert ;$$

$$\text{?} \text{indicates text missing or illegible when filed}$$

2.12) retaining curve segment of which the second derivative value is smaller than fₒᵤₜ according to shape and vibrating feature of the second derivative curve f_{(T}_{ₖ}_{Par}_{ₖ}₎, and obtaining the optimized threshold interval T=[Tₘᵢₙ,Tₘₐₓ] of the curve segment;

2.13) outputting the optimized threshold interval T=[Tₘᵢₙ,Tₘₐₓ], going to step 3);

3) streamlining the sound velocity profile,

3.1) inputting the sound velocity profile in_svp and the optimized threshold interval T=[Tₘᵢₙ,Tₘₐₓ];

3.2) setting

$$\text{?} = 0.01 \times ( {T}_{max} - {T}_{min} ) , \\ {T}_{k} = {T}_{min} ;$$

$$\text{?} \text{indicates text missing or illegible when filed}$$

3.3) initializing the current threshold T_{cur}=Tₖ;

initializing the current sound velocity profile dataset

$$\text{?} = in\_ \text{?} = {\{ {P}_{f} = ( \text{?} , \text{?} ) \}}_{j = 1 \text{?} , \text{?}} ;$$

$$\text{?} \text{indicates text missing or illegible when filed}$$

3.4) deleting redundant point of the sound velocity profile:

3.4.1) extracting the first point P_{c}=(dₐ,vₐ) and the last point P_{b}=(d_{b},v_{b}) of the current sound velocity profile dataset V_{cur};

3.4.2) traversing V_{cur}, extracting Pⱼ in order, applying equation (1) to calculate offset value Dⱼ in the sound velocity dimension of Pⱼ, storing the maximum offset value Dⱼ into Dₘₐₓ, and storing the corresponding sound velocity profile point Pⱼ into Pₖ;

3.4.3) if Dₘₛₓ>T_{cur}, adding Pₖ to Vₜₘₚ, partitioning the current sound velocity profile dataset V_{cur} from Pₖ into two segments, which are V_{cur1}={Pⱼ}_{j=a,k} and V_{cur2}={Pⱼ}_{j=k,a}, assigning V_{cur1} and V_{cur2} to V_{cur} and returning to step 3.4.1) to recalculate respectively;

3.4.4) if Dₘₐₓ≦T_{cur}, adding both P₁ and Pₘ to Vₜₘₚ;

3.5) outputting in_svpₜ and out_svpₜ;

4) estimating sound velocity profile precision,

4.1) inputting the original sound velocity profile V_{orig} and the streamlined sound velocity profile Vₛₜₘₚ;

4.2) inputting beam angle dataset B={θᵢ}_{i=1,nb}, wherein nb is the number of beam, and nb is natural number;

4.3) applying equation (2), calculating coordinates of the original sound velocity profile V_{orig} and the streamlined sound velocity profile Vₛₜₘₚ, which are (Orig_F_xᵢ,Orig_F_dᵢ) and (Stmp_F_xᵢ,Stmp_F_dᵢ) respectively;

$$\{ \begin{matrix}\text{?} = \text{?} {v}_{j} \times sin ( \text{?} ) \\ \text{?} = \text{?} \text{?} \times cos ( \text{?} )\end{matrix} \\ \text{?} \text{indicates text missing or illegible when filed} \qquad ( 2 )$$

wherein αᵢ is a beam angle, and the initial value of αᵢ is θᵢ; wherein vⱼ is sound velocity value;

4.4) applying equation (3), calculating horizontal error percentage ε_xᵢ and vertical error percentage ε_dᵢ;

$$\{ \begin{matrix}{s\_x}_{i} = \frac{( Orig\_F {\_x}_{i} - Simp\_F {\_x}_{i} )}{Orig\_F {\_x}_{i}} \times 100 \% \\ {s\_d}_{i} = \frac{( Orig\_F {\_d}_{i} - Simp\_F {\_d}_{i} )}{Orig\_F {\_d}_{i}} \times 100 \%\end{matrix} \qquad ( 3 )$$

4.5) for each beam angle {θᵢ=Bᵢ}_{t=1,nb}, applying from the step 4.3) to step 4.5), obtaining horizontal error percentage dataset {ε_xᵢ}_{t=1,nb} and vertical error percentage dataset {x_dᵢ}_{i=1,nb};

4.6) applying equation (4) to calculate mean value μₓ and mean squared deviation value σₓ of the horizontal error percentage;

$$\{ \begin{matrix}\text{?} \\ \text{?} = \sqrt{\frac{1}{nb} \text{?}}\end{matrix} \\ \text{?} \text{indicates text missing or illegible when filed} \qquad ( 4 )$$

4.7) applying equation (5) to calculate mean value μ_{d} and mean squared deviation value σ_{d} of the vertical error percentage;

$$\{ \begin{matrix}\text{?} \\ {σ}_{d} = \sqrt{\frac{1}{nb} \text{?} {( \text{?} - {μ}_{d} )}^{2}}\end{matrix} \\ \text{?} \text{indicates text missing or illegible when filed} \qquad ( 5 )$$

4.8) assessing precision

if σ_{d}>0.1%, then Tₖ=Tₖ−Tₛₜₑₚ, returning to the step 3.4);

if σ_{d}<0.1%, then Tₖ=Tₖ+Tₛₜₑₚ, returning to the step 3.4);

if σ_{d}=0.1%, outputting Vₛₜₘₚ;

5) processing the sound velocity profiles in order,

5.1) storing the streamlined sound velocity profile Vₛₜₘₚ into sound velocity profile dataset SVPₒᵤₜ={out_svpₜ}_{t=1,n}, wherein out_svpₜ=Vₛₜₘₚ;

5.2) importing a sound velocity profile from the original sound velocity profile dataset SVPₘ={in_svpₜ}_{t=1,n} in order, returning to the step 2), processing all the sound velocity profiles;

6) making use of the streamlined sound velocity profiles,

importing the streamlined sound velocity profile dataset SVPₒᵤₜ into multi-beam echo sounding system and data processing system, for multi-beam echo sounding survey and data processing.

### Advantages of the Invention

The invention discloses a sound velocity profile streamlining and optimization method based on maximum offset of velocity. The advantage of the method is displayed with its integrity, rapidity and intelligence. The processed sound velocity profiles are provided with fidelity and efficiency characteristics. The method is capable to retain feature points of original sound velocity profiles, and to evaluate optimal sound velocity profile from different sound velocity combinations speedily, streamlined sound velocity profile complies with the accuracy requirements of multi-beam echo sounding survey according to ray-tracing and precision assessment of mean squared deviation. Therefore, the most prominent advantage of the method is that 90% of redundant points are deleted under the precondition to ensure the accuracy of sound velocity profiles, so as to achieve a significant reduction of computation time and improve work efficiency. The method has an important application value in multi-beam echo sounding survey and data processing.

### BRIEF DESCRIPTION OF THE FIGURES

FIG. 1 illustrates a flowchart in the embodiment of the present invention.

FIG. 2 illustrates a flowchart of determining optimized threshold interval in FIG. 1.

FIG. 3 illustrates a flowchart of streamlining sound velocity profile in FIG. 1.

FIG. 4 illustrates a flowchart of estimating precision in FIG. 1.

FIG. 5 illustrates streamlined sound velocity profiles under different thresholds in the embodiment of the present invention.

FIG. 6 illustrates a schematic diagram of ray tracing error analysis method in the embodiment of the present invention.

FIG. 7 illustrates original sound velocity profile dataset in the embodiment of the present invention.

FIG. 8 illustrates a relationship diagram of threshold, reduction rate and second derivative in the embodiment of the present invention.

FIG. 9 illustrates mean error percentage of all streamlined sound velocity profiles under different thresholds in the embodiment of the present invention.

FIG. 10 illustrates the relationship diagram of threshold, reduction rate and computing time in the embodiment of the present invention.

### DETAILED DESCRIPTION OF THE INVENTION

These and other features, aspects, and advantages of the present invention will be better understood with regard to the following description, appended claims, and accompanying drawings.

The following embodiments described by reference drawings are exemplary, which are only used to explain the present invention, and not regarded as the limitations of the present invention.

### Example 1

Sound Velocity Profile (SVP) Streamlining and Optimization Method Based on Maximum Offset of Velocity, comprising the steps of:

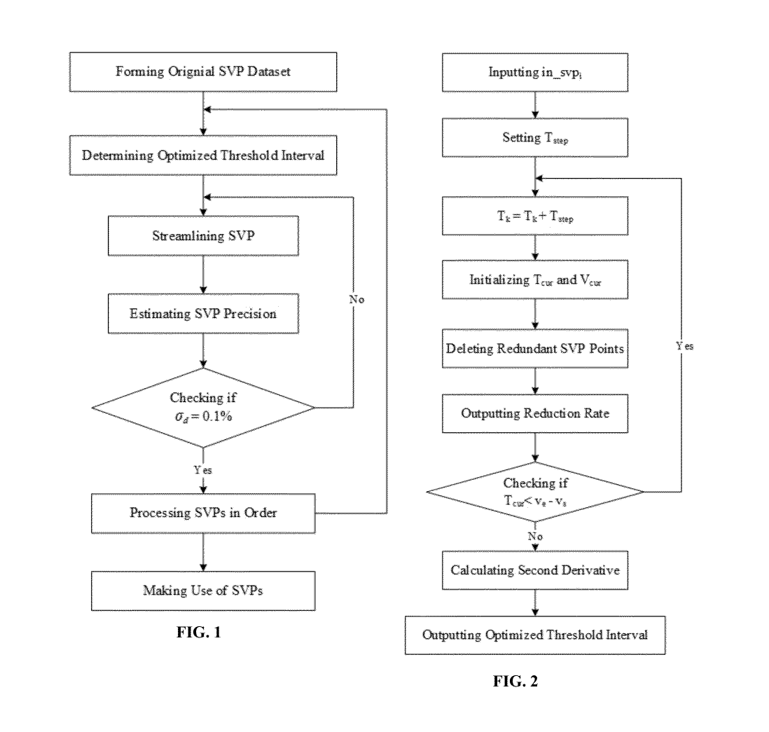

FIG. 1 illustrates a flowchart in the embodiment of the present invention;
1) forming original sound velocity profile dataset,

1.1) if there are sound velocity profiles, forming the original sound velocity profile dataset SVPᵢₙ={in_svpₜ}_{t=1,n} directly, wherein i is numerical order of the sound velocity profile, n is the number of the collected sound velocity profiles, i and n are both natural numbers;

1.2) if there are no sound velocity profiles, using sound velocity profile acquisition apparatus, obtaining the original sound velocity profiles, forming the original sound velocity profile dataset SVPᵢₙ={in_svpₜ}_{t=1,n};

1.3) for each said sound velocity profile in_svpₜ={Pⱼ=(dⱼ,vⱼ)}_{j=1,m}, wherein Pⱼ is a sound velocity profile point, dⱼ and vⱼ are corresponding depth value and sound velocity value of each said sound velocity profile point Pⱼ respectively, m is the number of the valid sound velocity profile points, j and m are both natural numbers;

1.4) outputting a sound velocity profile in_svpₜ;

2) determining optimized threshold interval (FIG. 2 illustrates a flowchart of determining optimized threshold interval in FIG. 1),

2.1) inputting the sound velocity profile in_svpₜ;

2.2) traversing the sound velocity profile in_svpₜ, obtaining minimum vₛ and maximum vₛ of the sound velocity profile;

$$\text{?} = 0.001 \times ( \text{?} - \text{?} ) , \\ \text{?} \text{indicates text missing or illegible when filed}$$

wherein Tₛₜₑₚ is an automatically calculating step of threshold;

initializing Tₖ=0, wherein Tₖ is the present sound velocity streamlining threshold;

2.3) setting the threshold automatically: Tₖ=Tₖ+Tₛₜₑₚ;

2.4) initializing current threshold

$$\text{?} = {T}_{k} , \text{?} ∈ {in\_svp}_{i} , \\ \text{?} \text{indicates text missing or illegible when filed}$$

wherein V_{cur} is current processing sound velocity profile segment,

$$\text{?} = {\{ {P}_{j} = ( \text{?} , \text{?} ) \}}_{j = a , b} , \\ \text{?} \text{indicates text missing or illegible when filed}$$

wherein a is first point and b is last point of the current processing sound velocity profile segment, and both a and b are natural numbers; initializing

$$\text{?} = in\_ \text{?} = {\{ {P}_{j} = ( {d}_{j} , {v}_{j} ) \}}_{\text{?} = 1 , m} ;$$

$$\text{?} \text{indicates text missing or illegible when filed}$$

2.5) deleting redundant point of the sound velocity profile:

2.5.1) extracting the first point

$${P}_{a} = ( {d}_{a} , \text{?} ) and the last point \text{?} = ( d \text{?} , \text{?} )$$

$$\text{?} \text{indicates text missing or illegible when filed}$$

of the current sound velocity profile dataset V_{cur};

2.5.2) traversing the current sound velocity dataset V_{cur}, extracting each said sound velocity profile point Pⱼ in order, applying equation (1) to calculate offset value Dⱼ in sound velocity dimension of Pⱼ:

$${D}_{j} = \text{?} [ \frac{( {v}_{j} - {v}_{a} ) \text{?} ( {d}_{j} - {d}_{a} )}{{v}_{b} - {v}_{a}} + {d}_{a} - {v}_{j} ] \\ \text{?} \text{indicates text missing or illegible when filed} \qquad ( 1 )$$

storing maximum offset value Dⱼ into Dₘₐₓ, and storing the corresponding sound velocity profile point Pⱼ into Pₖ, wherein Pₖ is a temporary sound velocity profile;

2.5.3) if Dₘₐₓ>T_{cur}, adding Pₖ to Vₜₘₚ, wherein Vₜₘₚ is a temporary sound velocity profile dataset, partitioning the current sound velocity profile dataset V_{cur} from Pₖ into two segments, which are

$$\text{?} = {\{ \text{?} \}}_{j = \text{?}} and \text{?} = {\{ \text{?} \}}_{j = k , b} ;$$

$$\text{?} \text{indicates text missing or illegible when filed}$$

2.5.4) if Dₘₐₓ≦T_{cur}, adding P₁ and Pₘ to Vₜₘₚ;

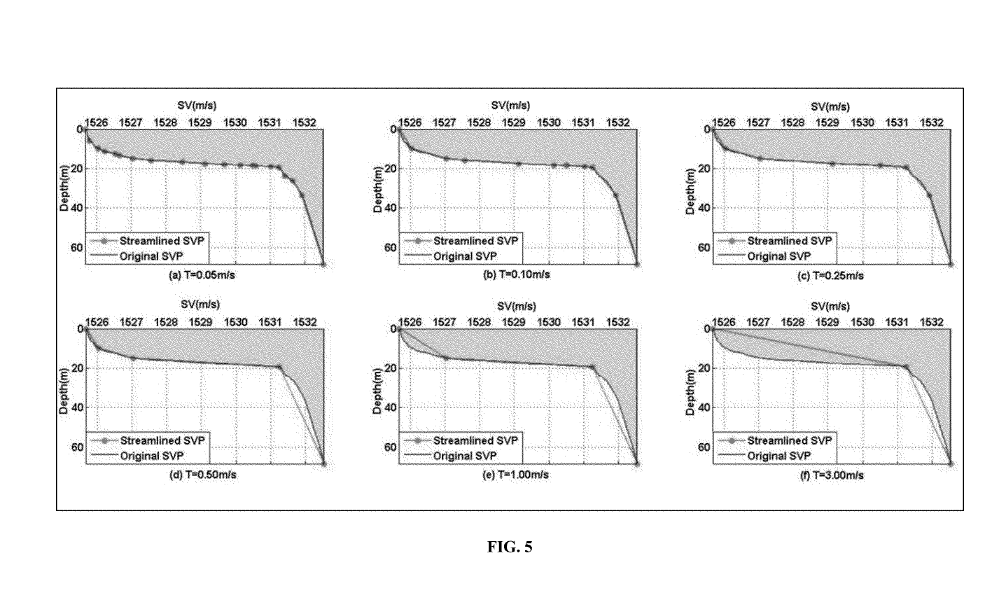

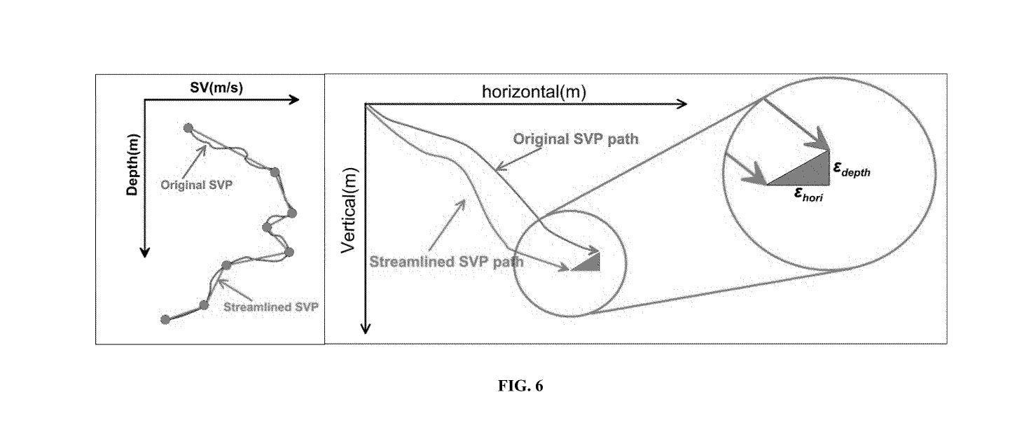

2.6) outputting streamlined sound velocity profile:

$$out\_ \text{?} = {V}_{tmp} = {\{ {P}_{j} = ( {d}_{j} , \text{?} ) \}}_{\text{?} = \text{?}} , \\ \text{?} \text{indicates text missing or illegible when filed}$$

wherein mo is the number of streamlined sound velocity profile points, and mo is a natural number; wherein out_svgₜ is corresponding to in_svpₜ, and out_svpₜ is a new sound velocity profile formed by reducing redundancy under the threshold T_{cur}; FIG. 5 illustrates streamlined sound velocity profiles under different thresholds in the embodiment of the present invention.

2.7) outputting reduction rate:

$$\text{?} = ( 1 - \frac{mo}{m} ) \times 100 \% ;$$

$$\text{?} \text{indicates text missing or illegible when filed}$$

2.8) obtaining reduction rate parameter Parₖ, adding Parₖ to dataset

$${\{ ( {T}_{k} , \text{?} ) \}}_{k = 1 , ( \text{?} - \text{?} ) \times 1000} ;$$

$$\text{?} \text{indicates text missing or illegible when filed}$$

2.9) if

$$\text{?} < \text{?} - \text{?} , \\ \text{?} \text{indicates text missing or illegible when filed}$$

returning to the step 2.3);

2.10) using Tₖ as horizontal axis, Parₖ as vertical axis, obtaining reduction rate curve, and calculating second derivative of the reduction rate, obtaining second derivative curve f_{(T}_{ₖ}_{Par}_{ₖ}₎;

2.11) traversing the second derivative curve f_{(T}_{ₖ}_{Par}_{ₖ}₎, obtaining absolute value interval [fₘᵢₙ,fₘₐₓ], setting curve blocking value fₒᵤₜ=0.1×|fₘₐₓ−fₘᵢₙ|;

2.12) retaining curve segment of which the second derivative value is smaller than fₒᵤₜ according to shape and vibrating feature of the second derivative curve f_{(T}_{ₖ}_{Par}_{ₖ}₎, and obtaining the optimized threshold interval T=[Tₘᵢₙ,Tₘₐₓ] of the curve segment;

2.13) outputting the optimized threshold interval T=[Tₘᵢₙ,Tₘₐₓ], going to step 3);

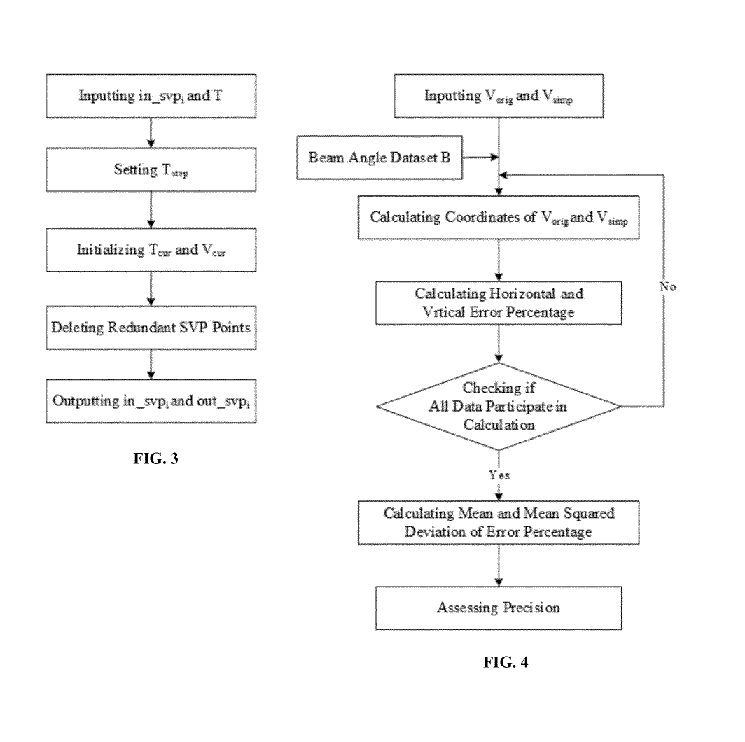

3) streamlining the sound velocity profile (FIG. 3 illustrates a flowchart of streamlining sound velocity profile in FIG. 1),

3.1) inputting the sound velocity profile in_svp and the optimized threshold interval T=[Tₘᵢₙ,Tₘₐₓ];

3.2) setting Tₛₜₑₚ=0.01×(Tₘₐₓ−Tₘᵢₙₓ), Tₖ=Tₘᵢₙ;

3.3) initializing the current threshold T_{cur}=Tₖ;

initializing the current sound velocity profile dataset V_{cur}=in_svpₜ={Pⱼ=(dⱼ,vⱼ)}_{j=1,m};

3.4) deleting redundant point of the sound velocity profile:

3.4.1) extracting the first point P_{c}=(dₐ,vₐ) and the last point P_{b}=(d_{b},v_{b}) of the current sound velocity profile dataset V_{cur};

3.4.2) traversing V_{cur}, extracting Pⱼ in order, applying equation (1) to calculate offset value Dⱼ in the sound velocity dimension of Pⱼ, storing the maximum offset value Dⱼ into Dₘₐₓ, and storing the corresponding sound velocity profile point Pⱼ into Pₖ;

3.4.3) if Dₘₛₓ>T_{cur}, adding Pₖ to Vₜₘₚ, partitioning the current sound velocity profile dataset V_{cur} from Pₖ into two segments, which are V_{cur1}={Pⱼ}_{j=a,k} and V_{cur2}={Pⱼ}_{j=k,a}, assigning V_{cur1} and V_{cur2} to V_{cur} and returning to step 3.4.1) to recalculate respectively;

3.4.4) if Dₘₐₓ≦T_{cur}, adding both P₁ and Pₘ to Vₜₘₚ;

3.5) outputting in_svpₜ and out_svpₜ;

4) estimating sound velocity profile precision (FIG. 4 illustrates a flowchart of estimating precision in FIG. 1),

4.1) inputting the original sound velocity profile V_{orig} and the streamlined sound velocity profile Vₛₜₘₚ;

4.2) inputting beam angle dataset B={θᵢ}_{i=1,nb}, wherein nb is the number of beam, and nb is natural number;

4.3) applying equation (2), calculating coordinates of the original sound velocity profile V_{orig} and the streamlined sound velocity profile Vₛₜₘₚ, which are (Orig_F_xᵢ,Orig_F_dᵢ) and (Stmp_F_xᵢ,Stmp_F_dᵢ) respectively;

$$\{ \begin{matrix}\text{?} = {\sum }_{j = 1}^{m} {v}_{j} \times sin ( \text{?} ) \\ \text{?} = {\sum }_{j = 1}^{m} {v}_{j} \times cos ( \text{?} )\end{matrix} \\ \text{?} \text{indicates text missing or illegible when filed} \qquad ( 2 )$$

wherein αᵢ is a beam angle, and the initial value of αᵢ is θᵢ; wherein vⱼ is sound velocity value;

4.4) applying equation (3), calculating horizontal error percentage ε_xᵢ and vertical error percentage ε_dᵢ;

$$\{ \begin{matrix}{s\_x}_{i} = \frac{( Orig\_F {\_x}_{i} - Simp\_F {\_x}_{i} )}{Orig\_F {\_x}_{i}} \times 100 \% \\ {s\_d}_{i} = \frac{( Orig\_F {\_d}_{i} - Simp\_F {\_d}_{i} )}{Orig\_F {\_d}_{i}} \times 100 \%\end{matrix} \qquad ( 3 )$$

4.5) for each beam angle {θᵢ=Bᵢ}_{t=1,nb}, applying from the step 4.3) to step 4.5), obtaining horizontal error percentage dataset {ε_xᵢ}_{t=1,nb} and vertical error percentage dataset {s_dᵢ}_{i=1,nb};

4.6) applying equation (4) to calculate mean value μₓ and mean squared deviation value σₓ of the horizontal error percentage;

$$\{ \begin{matrix}\text{?} \\ \text{?} = \sqrt{\frac{1}{nb} \text{?}}\end{matrix} \\ \text{?} \text{indicates text missing or illegible when filed} \qquad ( 4 )$$

4.7) applying equation (5) to calculate mean value μ_{d} and mean squared deviation value σ_{d} of the vertical error percentage;

$$\{ \begin{matrix}{μ}_{d} = \frac{{\sum }_{i = 1}^{nb} \text{?}}{nb} \\ {σ}_{d} = \sqrt{\frac{1}{nb} {\sum }_{i = 1}^{nb} {( {s\_d}_{i} - {μ}_{d} )}^{2}}\end{matrix} \\ \text{?} \text{indicates text missing or illegible when filed} \qquad ( 5 )$$

4.8) assessing precision

if σ_{d}>0.1%, then Tₖ=Tₖ−Tₛₜₑₚ, returning to the step 3.4);

if σ_{d}<0.1%, then Tₖ=Tₖ+Tₛₜₑₚ, returning to the step 3.4);

if σ_{d}=0.1%, outputting Vₛₜₘₚ;

5) processing the sound velocity profiles in order,

5.1) storing the streamlined sound velocity profile Vₛₜₘₚ into sound velocity profile dataset SVPₒᵤₜ={out_svpₜ}_{t=1,n}, wherein out_svpₜ=Vₛₜₘₚ;

5.2) importing a sound velocity profile from the original sound velocity profile dataset SVPₘ={in_svpₜ}_{t=1,n} in order, returning to the step 2), processing all the sound velocity profiles;

6) making use of the streamlined sound velocity profiles,

importing the streamlined sound velocity profile dataset SVPₒᵤₜ into multi-beam echo sounding system and data processing system, for multi-beam echo sounding survey and data processing.

### Example 2

In order to assess the influence of streamlined sound velocity profiles on multi-beam echo sounding survey and data processing, in this Example, we applied the technical processes in Example 1, adopted the measured sound velocity profiles to conduct streamlining and estimating, and adopted the measured multi-beam echo sounding data to evaluate processing efficiency of sound velocity profiles under different thresholds, and specific procedures were as follows:

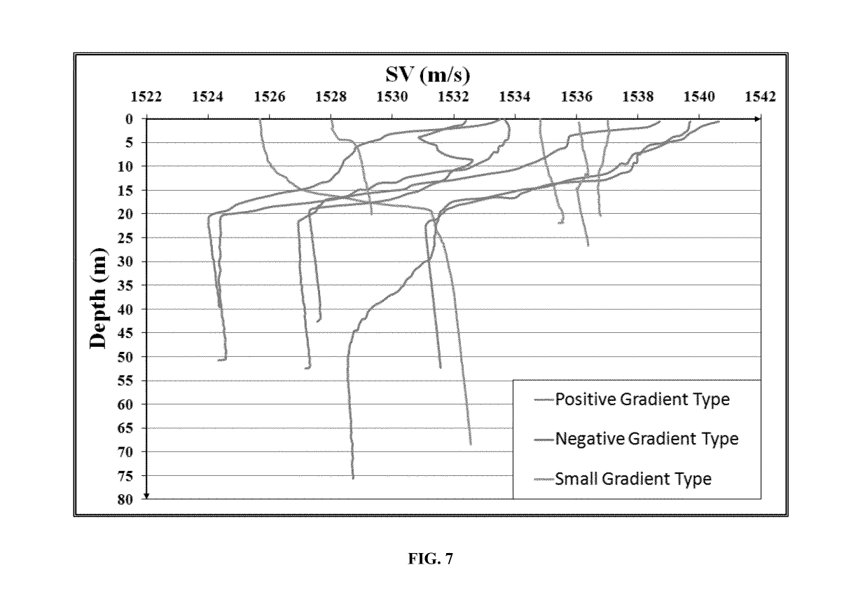

(1) forming original sound velocity profile dataset: adopting measured sound velocity profile dataset to inspect the method. Acquisition apparatus was XR-420 CTD, 11 measured sound velocity profiles were obtained. For the analysis and classification, sound velocity profiles obtained can be classified into 3 types (FIG. 7): (a) positive gradient type: sound velocity increased with depth; (b) negative gradient type: sound velocity decreased with depth; (c) small gradient type: sound velocity almost unchanged with increasing depth, and forming sound velocity profile dataset for all data.

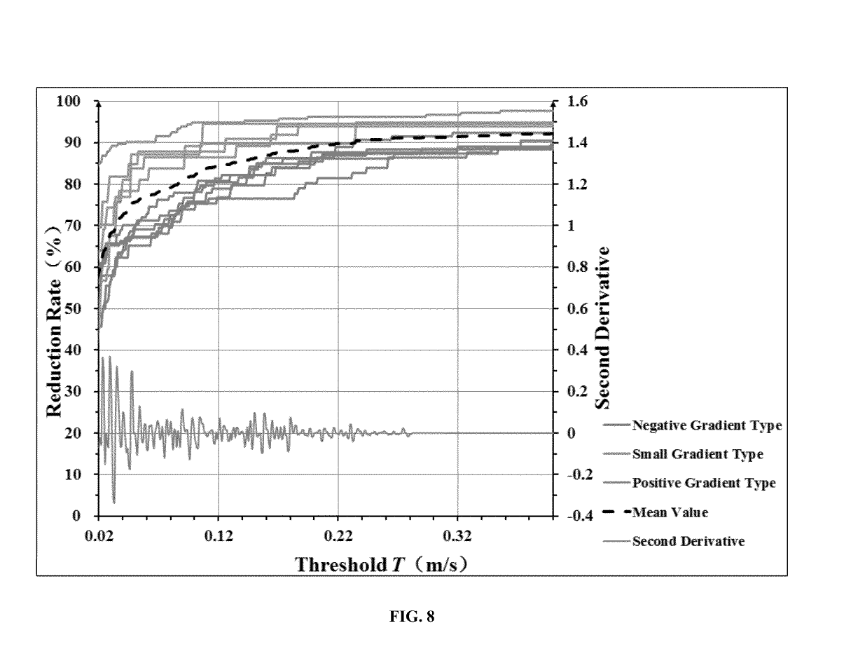

(2) determining optimized threshold interval: according to steps shown in FIG. 2, processing the measured sound velocity profiles under different thresholds, obtaining relationship diagram of threshold, reduction rate and second derivative (FIG. 8). Black solid line in FIG. 8 was second derivative of mean reduction rate of the 11 sound velocity profiles. If the threshold was 0.04 m/s, second derivative abruptly reduced to about 0.1, and if the threshold reached 0.18 m/s, second derivative gradually approached 0. We can see that for a specific sound velocity profile, there was a threshold interval [T₁, T₂], T₁ and T₂ were the value which second derivative of the reduction rate had an abrupt change. The optimized threshold interval can be derived by analyzing second derivative curve.

(3) streamlining sound velocity profile: according to steps shown in FIG. 3, obtaining 11 corresponding streamlined sound velocity profiles according to the optimized threshold interval in step (2).

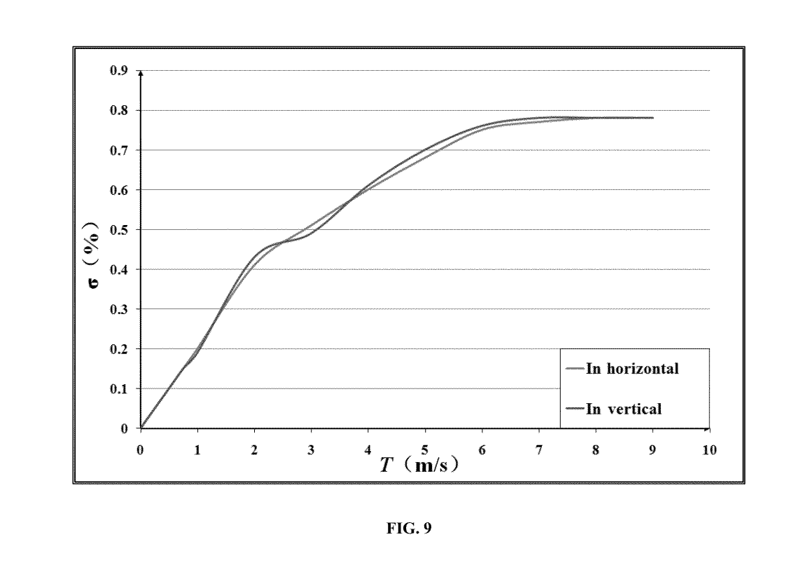

(4) estimating sound velocity profiles precision: FIG. 9 illustrated mean error percentage of all streamlined sound velocity profiles under different thresholds. If the threshold Tε[0, 1], there was a linear relationship for standard deviation of error percentage between threshold and sounding data, the slope was 0.2; if the threshold Tε[1, 7], there was a nonlinear relationship for standard deviation of error percentage between threshold and sounding data. We streamlined SVP under conditions that standard deviation of depth error percentage equaled to 0.1%, and obtained a series of streamlined sound velocity profiles.

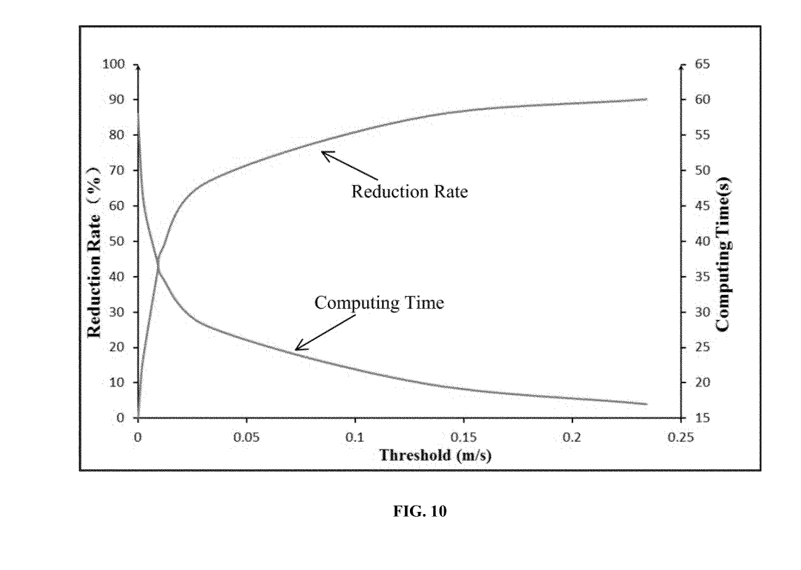

(5) making use of streamlined sound velocity profile: selecting a number of original sound velocity profiles and streamlined sound velocity profiles to evaluate the influence before and after streamlined sound velocity profiles on data processing efficiency. Multi-beam echo sounding acquisition apparatus was Elac Bottom Chart 1180/1050 dual-frequency shallow water multi-beam echo sounding system, measured depth range was 40-50 m, 40 survey lines were selected, total file size was 390 Mb, survey line length was 498 Km, and the number of valid beam points was 5.8316 million; using multi-beam data processing software Canis HIPS 7.1 to conduct data processing and computing time statistics. As shown in FIG. 10, if the threshold was 0, namely using the original sound velocity profile, ray tracing time was 58 s. Reduction rate was increased with increasing threshold, and corresponding ray tracing time presented nonlinear decreasing trend. When reduction rate reached 90%, ray tracing time was 17 s. FIG. 10 illustrated the relationship diagram of threshold, reduction rate and computing time.

The streamlined sound velocity profiles were capable to significantly reduce computing time of data processing under the premise to ensure data accuracy, and work efficiency was improved 3.41 times. It is known that enhancing work efficiency is crucial to engineering applications of multi-beam echo sounding survey and data processing.

What is claimed is:

1. A sound velocity profile (SVP) streamlining and optimization method based on maximum offset of velocity, comprising the steps of:
1) forming an original sound velocity profile dataset,
1.1) if there are sound velocity profiles, forming the original sound velocity profile dataset
$${SVP}_{i n} = {\{ in\_ \text{?} \}}_{i = 1 , n}$$
$$\text{?} \text{indicates text missing or illegible when filed}$$
directly, wherein i is numerical order of the sound velocity profile, n is the number of the collected sound velocity profiles, i and n are both natural numbers;
1.2) if there are no sound velocity profiles, using a sound velocity profile acquisition apparatus to obtain the original sound velocity profiles, forming the original sound velocity profile dataset
$${SVP}_{i n} = {\{ in\_ \text{?} \}}_{\text{?} = 1 , n} ;$$
$$\text{?} \text{indicates text missing or illegible when filed}$$
1.3) for each said sound velocity profile
$${in\_svp}_{t} = {\{ {P}_{j} = ( {d}_{j} , {v}_{j} ) \}}_{\text{?} = \text{?} , m} , \\ \text{?} \text{indicates text missing or illegible when filed}$$
wherein Pⱼ is a sound velocity profile point, dⱼ and vⱼ are corresponding depth value and sound velocity value of each said sound velocity profile point Pⱼ respectively, m is the number of the valid sound velocity profile points, j and m are both natural numbers;
1.4) outputting a sound velocity profile in_svpₜ;
2) determining optimized threshold interval,
2.1) inputting the sound velocity profile in_svpₜ;
2.2) traversing the sound velocity profile in_svpₜ, obtaining minimum vₛ and maximum vₛ of the sound velocity profile;
$${T}_{step} = 0.001 \times ( \text{?} - \text{?} ) , \\ \text{?} \text{indicates text missing or illegible when filed}$$
wherein Tₛₜₑₚ is an automatically calculating step of threshold;
initializing Tₖ=0, wherein Tₖ is the present sound velocity streamlining threshold;
2.3) setting the threshold automatically: Tₖ=Tₖ+Tₛₜₑₚ;
2.4) initializing current threshold T_{cur}=Tₖ, V_{cur}εin_svpₜ, wherein V_{cur} is current processing sound velocity profile segment, V_{cur}={Pⱼ=(dⱼ,vⱼ)}_{j=a,b}, wherein a is first point and b is last point of the current processing sound velocity profile segment, and both a and b are natural numbers; initializing V_{cur}=in_svpₜ={Pⱼ=(dⱼ,vⱼ)}_{j=1,m};
2.5) deleting redundant point of the sound velocity profile:
2.5.1) extracting the first point Pₐ=(dₐ,vₐ) and the last point P_{b}=(d_{b},v_{b}) of the current sound velocity profile dataset V_{cur};
2.5.2) traversing the current sound velocity dataset V_{cur}, extracting each said sound velocity profile point Pⱼ in order, applying equation (1) to calculate offset value Dⱼ in sound velocity dimension of Pⱼ:
$${D}_{j} = abs [ \frac{( {v}_{j} - {v}_{a} ) \text{?} ( {d}_{j} - {d}_{a} )}{{v}_{b} - {v}_{a}} + {d}_{a} - {v}_{j} ] \\ \text{?} \text{indicates text missing or illegible when filed} \qquad ( 1 )$$
storing maximum offset value Dⱼ into Dₘₐₓ, and storing the corresponding sound velocity profile point Pⱼ into Pₖ, wherein Pₖ is a temporary sound velocity profile;
2.5.3) if Dₘₐₓ>T_{cur}, adding Pₖ to Vₜₘₚ, wherein Vₜₘₚ is a temporary sound velocity profile dataset, partitioning the current sound velocity profile dataset V_{cur} from Pₖ into two segments, which are V_{cur1}={Pⱼ}_{j=a,k} and V_{cur2}={Pⱼ}_{j=k,b};
2.5.4) if Dₘₐₓ≦T_{cur}, adding P₁ and Pₘ to Vₜₘₚ;
2.6) outputting streamlined sound velocity profile: out_svpₜ=Vₜₘₚ−{Pⱼ=(dⱼ,vⱼ)}_{j=1,mo}, wherein mo is the number of streamlined sound velocity profile points, and mo is a natural number; wherein out_svgₜ is corresponding to in_svpₜ, and out_svpₜ is a new sound velocity profile formed by reducing redundancy under the threshold T_{cur};
2.7) outputting reduction rate:
$${Per}_{i} = ( 1 - \frac{mo}{m} ) \times 100 \% ;$$
2.8) obtaining reduction rate parameter Parₖ, adding Parₖ to dataset
$${\{ ( {T}_{k} , \text{?} ) \}}_{k = 1 , ( \text{?} - \text{?} ) \times 1000} ;$$
$$\text{?} \text{indicates text missing or illegible when filed}$$
2.9) if T_{cur}<vₑ−v [symbol] , returning to the step 2.3);
2.10) using Tₖ as horizontal axis, Parₖ as vertical axis, obtaining reduction rate curve, and calculating second derivative of the reduction rate, obtaining second derivative curve f_{(T}_{ₖ}_{Par}_{ₖ}₎;
2.11) traversing the second derivative curve f_{(T}_{ₖ}_{Par}_{ₖ}₎, obtaining absolute value interval [fₘᵢₙ,fₘₐₓ], setting curve blocking value fₒᵤₜ=0.1×|fₘₐₓ−fₘᵢₙ|;
2.12) retaining curve segment of which the second derivative value is smaller than fₒᵤₜ according to shape and vibrating feature of the second derivative curve f_{(T}_{ₖ}_{Par}_{ₖ}₎, and obtaining the optimized threshold interval T=[Tₘᵢₙ,Tₘₐₓ] of the curve segment;
2.13) outputting the optimized threshold interval T=[Tₘᵢₙ,Tₘₐₓ], going to step 3);
3) streamlining the sound velocity profile,
3.1) inputting the sound velocity profile in_svp and the optimized threshold interval T=[Tₘᵢₙ,Tₘₐₓ];
3.2) setting Tₛₜₑₚ=0.01×(Tₘₐₓ−Tₘᵢₙₓ), Tₖ=Tₘᵢₙ;
3.3) initializing the current threshold T_{cur}=Tₖ;
initializing the current sound velocity profile dataset V_{cur}=in_svpₜ={Pⱼ=(dⱼ,vⱼ)}_{j=1,m};
3.4) deleting redundant point of the sound velocity profile:
3.4.1) extracting the first point P_{c}=(dₐ,vₐ) and the last point P_{b}=(d_{b},v_{b}) of the current sound velocity profile dataset V_{cur};
3.4.2) traversing V_{cur}, extracting Pⱼ in order, applying equation (1) to calculate offset value Dⱼ in the sound velocity dimension of Pⱼ, storing the maximum offset value Dⱼ into Dₘₐₓ, and storing the corresponding sound velocity profile point Pⱼ into Pₖ;
3.4.3) if Dₘₛₓ>T_{cur}, adding Pₖ to Vₜₘₚ, partitioning the current sound velocity profile dataset V_{cur} from Pₖ into two segments, which are V_{cur1}={Pⱼ}_{j=a,k} and V_{cur2}={Pⱼ}_{j=k,a}, assigning V_{cur1} and V_{cur2} to V_{cur} and returning to step 3.4.1) to recalculate respectively;
3.4.4) if Dₘₐₓ≦T_{cur}, adding both P₁ and Pₘ to Vₜₘₚ;
3.5) outputting in_svpₜ and out_svpₜ;
4) estimating sound velocity profile precision,
4.1) inputting the original sound velocity profile V_{orig} and the streamlined sound velocity profile Vₛₜₘₚ;
4.2) inputting beam angle dataset B={θᵢ}_{i=1,nb}, wherein nb is the number of beam, and nb is natural number;
4.3) applying equation (2), calculating coordinates of the original sound velocity profile V_{orig} and the streamlined sound velocity profile Vₛₜₘₚ, which are (Orig_F_xᵢ,Orig_F_dᵢ) and (Stmp_F_xᵢ,Stmp_F_dᵢ) respectively;
$$\{ \begin{matrix}\text{?} = {\sum }_{j = 1}^{m} {v}_{j} \times sin ( \text{?} ) \\ \text{?} = {\sum }_{j = 1}^{m} {v}_{j} \times cos ( \text{?} )\end{matrix} \\ \text{?} \text{indicates text missing or illegible when filed} \qquad ( 2 )$$
wherein αᵢ is a beam angle, and the initial value of αᵢ is θᵢ; wherein vⱼ is sound velocity value;
4.4) applying equation (3), calculating horizontal error percentage ε_xᵢ and vertical error percentage ε_dᵢ;
$$\{ \begin{matrix}{s\_x}_{i} = \frac{( Orig\_F {\_x}_{i} - Simp\_F {\_x}_{i} )}{Orig\_F {\_x}_{i}} \times 100 \% \\ {s\_d}_{i} = \frac{( Orig\_F {\_d}_{i} - Simp\_F {\_d}_{i} )}{Orig\_F {\_d}_{i}} \times 100 \%\end{matrix} \qquad ( 3 )$$
4.5) for each beam angle {θᵢ=Bᵢ}_{t=1,nb}, applying from the step 4.3) to step 4.5), obtaining horizontal error percentage dataset {ε_xᵢ}_{t=1,nb} and vertical error percentage dataset {s_dᵢ}_{i=1,nb};
4.6) applying equation (4) to calculate mean value μₓ and mean squared deviation value σₓ of the horizontal error percentage;
$$\{ \begin{matrix}\text{?} \\ \text{?} = \sqrt{\frac{1}{nb} \text{?}}\end{matrix} \\ \text{?} \text{indicates text missing or illegible when filed} \qquad ( 4 )$$
4.7) applying equation (5) to calculate mean value μ_{d} and mean squared deviation value σ_{d} of the vertical error percentage;
$$\{ \begin{matrix}{μ}_{d} = \frac{{\sum }_{i = 1}^{nb} \text{?}}{nb} \\ {σ}_{d} = \sqrt{\frac{1}{nb} {\sum }_{i = 1}^{nb} {( {s\_d}_{i} - {μ}_{d} )}^{2}}\end{matrix} \\ \text{?} \text{indicates text missing or illegible when filed} \qquad ( 5 )$$
4.8) assessing precision
if σ_{d}>0.1%, then Tₖ=Tₖ−Tₛₜₑₚ, returning to the step 3.4);
if σ_{d}<0.1%, then Tₖ=Tₖ+Tₛₜₑₚ, returning to the step 3.4);
if σ_{d}=0.1%, outputting Vₛₜₘₚ;
5) processing the sound velocity profiles in order,
5.1) storing the streamlined sound velocity profile Vₛₜₘₚ into sound velocity profile dataset SVPₒᵤₜ={out_svpₜ}_{t=1,n}, wherein out_svpₜ=Vₛₜₘₚ;
5.2) importing a sound velocity profile from the original sound velocity profile dataset SVPₘ={in_svpₜ}_{t=1,n} in order, returning to the step 2), processing all the sound velocity profiles;
6) making use of the streamlined sound velocity profiles,
importing the streamlined sound velocity profile dataset SVPₒᵤₜ into multi-beam echo sounding system and data processing system, for multi-beam echo sounding survey and data processing.
